(19) United States
(12) Patent Application Publication
(10) Pub. No.: US 2017/0016543 A1
(43) Pub. Date: Jan. 19, 2017

(54) BALL VALVE STRUCTURE

(71) Applicant: BESSER VALVE INDUSTRIAL CO., LTD., Keelung City (TW)

(72) Inventors: Chang-Sung Yeh, Keelung City (TW); Che-Kuo Liao, Keelung City (TW)

(21) Appl. No.: 15/073,631

(22) Filed: Mar. 17, 2016

(30) Foreign Application Priority Data
Jul. 16, 2015 (TW) 104211492

(51) Int. Cl. F16K 5/06

(52) U.S. Cl. CPC F16K 5/0605; F16K 5/0647

(57) ABSTRACT

A ball valve structure includes : a first shell, having a first accommodation space defined inside the first shell and in communication with the outside and tube body configured on a top face of the first shell and in communication with the first accommodation space; support elements, encircled on an inner wall of the first accommodation space; a ball body, having a through hole in communication with the outside, a recess being configured on a top end of the ball body, the ball body being accepted in the first accommodation space, allowing the recess of the ball body to correspond to the tube body, and an outer side of the ball body being pressed against each support element; and a shaft body, one end thereof having an engagement portion, and the shaft body being coupled pivotally to the tube body, and the engagement portion being in engagement with the recess.

### TECHNICAL FIELD OF THE INVENTION

The present invention relates to a ball valve for controlling the flow, flow direction, pressure, temperature, and etc of a flowing fluid medium, and more particularly to a large ball valve, inside which a plurality of support elements adapted to support a ball body thereof are configured.

### DESCRIPTION OF THE PRIOR ART

For a long time, ball valves have been widely known. A conventional ball valve commonly includes: a main body, having a fluid inflow passage, fluid outflow passage and communication portion between the passages; a ball body, having a fluid communication passage and configured on the communication portion of the main body in a way of rotating around a reference axis; and a substantially cylindrical ball seat, configured between the ball body and main body, on the peripheral wall of which required openings are configured, thereby opening or closing the communication between the fluid inflow passage and fluid outflow passage by rotating the ball body around the reference axis.

However, in the field of large ball valve, the inner bottom of a ball valve bears a weight under the influence of gravitational force of the ball body inside the ball valve because the volume and weight of the ball body are large, and the ball body needs to be turned when in use so as to control whether fluid flows or not, resulting in the easy wear and tear, deformation or even damage of the inner bottom of the ball valve under gravitational force, pressure and friction.

### SUMMARY OF THE INVENTION

To overcome the defects mentioned above, a ball valve structure according to the present invention includes: a first shell, having a first accommodation space and tube body, the first accommodation space being defined inside the first shell and two ends thereof being in communication with the outside, and the tube body being configured on a top face of the first shell and in communication with the first accommodation space; a plurality of support elements, encircled on an inner wall of the first accommodation space; a ball body, having a through hole with two ends in communication with the outside, a recess being configured on a top end of the ball body, the ball body being accepted in the first accommodation space, allowing the recess of the ball body to correspond to the tube body, and an outer side of the ball body being pressed against each support element; and a shaft body, one end thereof having an engagement portion, and the shaft body being coupled pivotally to the tube body, and the engagement portion being in engagement with the recess.

The main object of the present invention is to provide a ball valve structure, using support elements to support the ball body to increase the support force of the first shell, and thereby decreasing the leak caused from the position offset and asymmetry of the ball body due to the weight and oppression of the ball body for a long period of time so as to extend the use of the ball valve.

### BRIEF DESCRIPTION OF THE DRAWINGS

FIG. 1 is a perspective view of the present invention;

FIG. 2 is an exploded view of the present invention;

FIG. 3 is a partly enlarged view of the present invention in FIG. 2;

FIG. 4 is a cross-sectional view of the present invention in a close state; and

FIG. 5 is a cross-sectional view of the present invention in an open state.

### DETAILED DESCRIPTION OF THE PREFERRED EMBODIMENTS

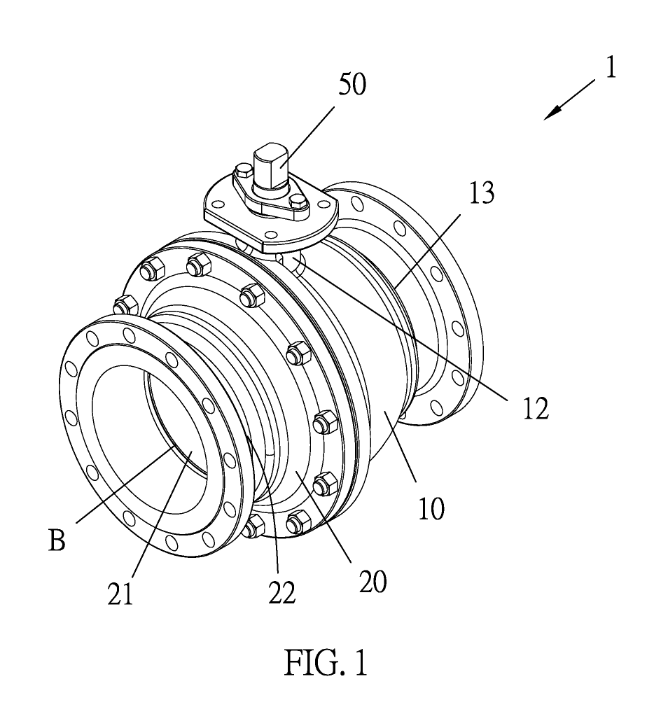

Referring to FIGS. 1 to 3, a ball valve structure of the present invention includes a first shell 10, a second shell 20, a plurality of support elements 30, a ball body 10 and a shaft body 50.

The first shell 10 has a first accommodation space 11 and a tube body 12, where the first accommodation space 11 is configured inside the first shell 10, the two ends of which are in communication with the outside, and the tube body 12 is configured on the top face of the first shell 10 and in communication with the first accommodation space 11, and the second shell has a second accommodation space 21, two ends of which are in communication with the outside, where one side of the second shell 20 is in connection with the first shell 10, allowing the first accommodation space 11 to be in communication with the second accommodation space 21.

One end of the first shell 10 and one end of the second shell 20 are respectively contracted gradually, respectively forming a neck portion 13, 22. Furthermore, a ball pad B is configured on the inner wall of each neck portion 13, 22.

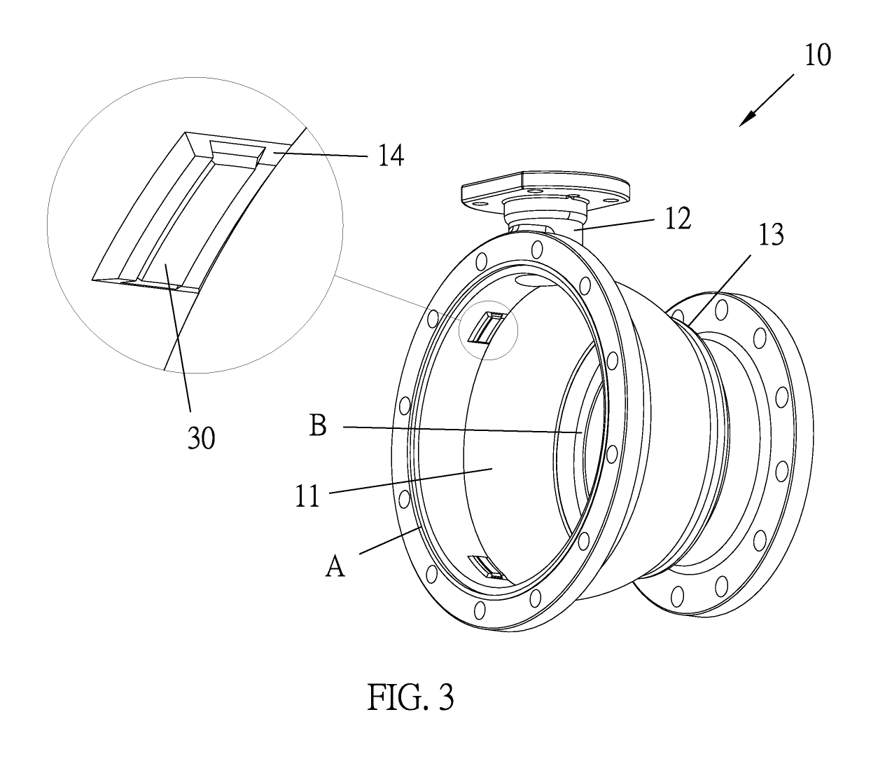

Referring to FIG. 3, a plurality of fixing portions 14 are further encircled inside the first accommodation space 11.

An elastic element A is configured on the inner side of the relative binding of the first shell 10 and second shell 20 mentioned above.

A plurality of support elements 30 are encircled on the inner wall of the first accommodation space 11, and in combination with the respective fixing portions 14.

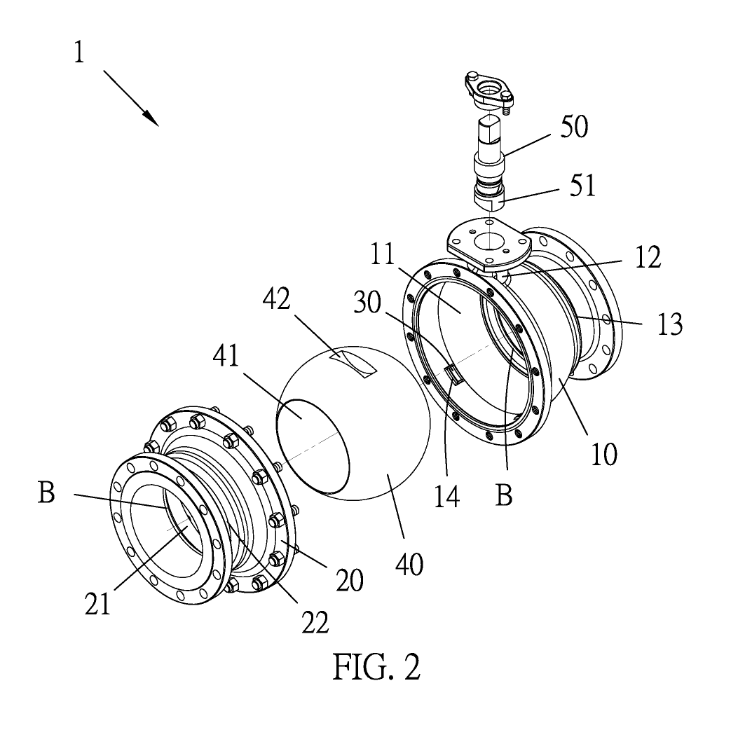

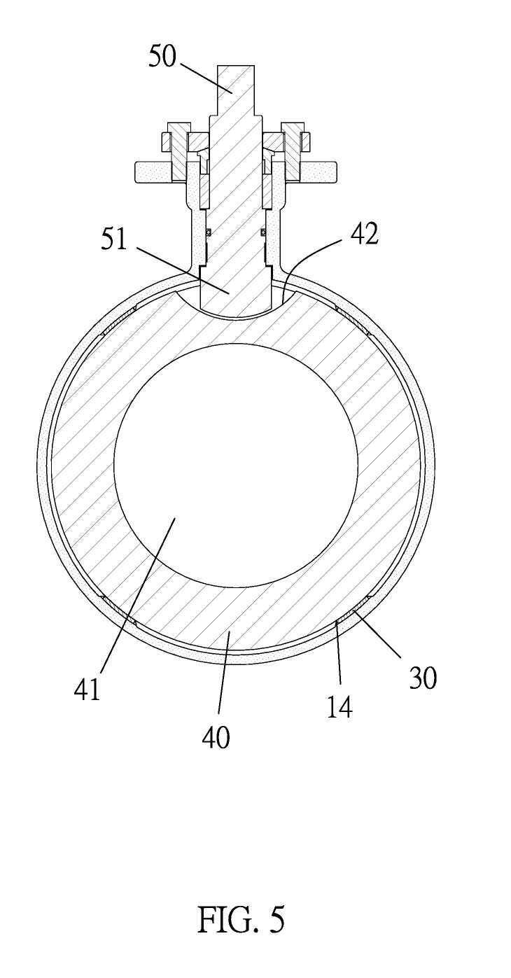

Referring to FIGS. 2 to 5, the ball body 40 has a through hole 41, the two ends of which are in communication with the outside, and on the top end of which a recess 42 is configured, where the ball body 40 is accepted in the first accommodation space 11 and second accommodation space 21, allowing the recess 42 of the ball body 40 to correspond to the tube body 12. Furthermore, the outside of the ball body 40 is pressed against each support element 30.

One end of the shaft body 50 mentioned above has an engagement portion 51, and the shaft body 50 itself is coupled pivotally to the tube body 12, with the engagement portion 51 being in combination with the recess 42.

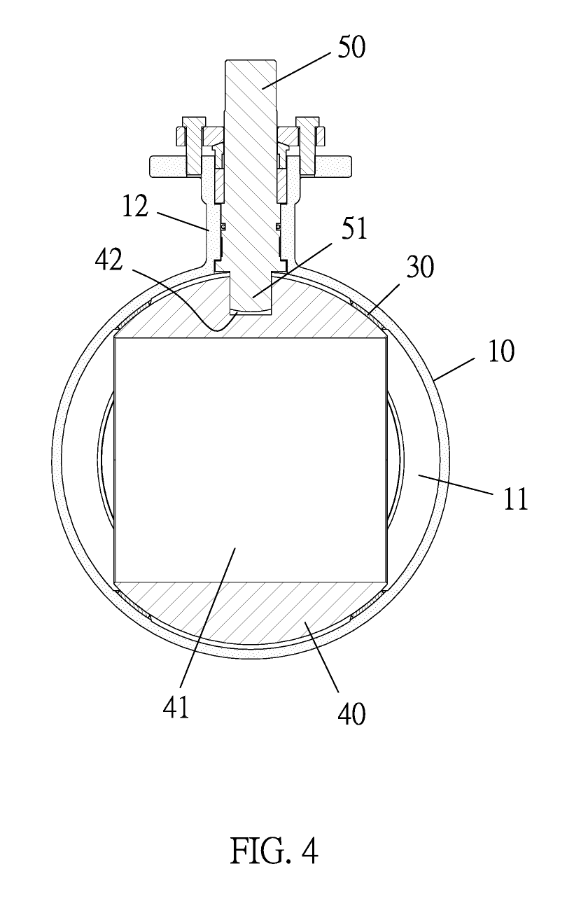

Referring to FIG. 4, rotating the shaft body 50 drives the ball body 40 to rotate, causing the ball body 40 to close both the first accommodation space 11 and second accommodation space 21 to form a locking state, thereby stopping fluid passing through.

Referring to FIG. 4, rotating shaft body 50 causes the ball body 40 to rotate, allowing the through hole 41 of the ball body 40 to be in communication both the first accommodation space 11 and second accommodation space 21, thereby allowing fluid to pass through.

With the above structure, the ball body 40 can be supported by all the support elements 30 to enhance the supporting force of the first shell 10, and thus to decrease the leak caused from the position offset and asymmetry of the ball body due to the weight, pressure and friction over a long period of time so as to extend the use of the ball valve.

I claim:

1. A ball valve structure, comprising:
a first shell, having a first accommodation space and tube body, said first accommodation space being defined inside said first shell and two ends thereof being in communication with the outside, and said tube body being configured on a top face of said first shell and in communication with said first accommodation space;
a plurality of support elements, encircled on an inner wall of said first accommodation space;
a ball body, having a through hole with two ends in communication with the outside, a recess being configured on a top end of said ball body, said ball body being accepted in said first accommodation space, allowing said recess of said ball body to correspond to said tube body, and an outer side of said ball body being pressed against each said support element; and
a shaft body, one end thereof having an engagement portion, said shaft body being coupled pivotally to said tube body, and said engagement portion being in engagement with said recess.

2. The structure according to claim 1, wherein one side of said first shell is bound to a second shell having a second accommodation space with two ends in communication with the outside, allowing said first accommodation space to be in communication with said second accommodation space, and said ball body is accepted in said first accommodation space and second accommodation space.

3. The structure according to claim 2, wherein an elastic element is configured on an inner side of a relative binding of said first shell and second shell.

4. The structure according to claim 3, wherein one end of said first shell and one end of said second shell are respectively contracted gradually to form a neck portion, and a ball pad is configured on an inner wall of each said neck portion.

5. The structure according to claim 1, wherein a plurality of fixing portions for accepting each said support element are further encircled inside said first accommodation space.

6. The structure according to claim 2, wherein a plurality of fixing portions for accepting each said support element are further encircled inside said first accommodation space.

7. The structure according to claim 3, wherein a plurality of fixing portions for accepting each said support element are further encircled inside said first accommodation space.

8. The structure according to claim 4, wherein a plurality of fixing portions for accepting each said support element are further encircled inside said first accommodation space.
